(19) United States
(12) Patent Application Publication
(10) Pub. No.: US 2013/0312315 A1
(43) Pub. Date: Nov. 28, 2013

(54) ALTERNATIVE UNIVERSAL FUEL AND PRODUCTION METHOD THEREOF

(71) Applicants: Yuri Alexandrovich Ivanov, Moscow (RU); Alexander Yurievich Frolov, Moscow (RU)

(72) Inventors: Yuri Alexandrovich Ivanov, Moscow (RU); Alexander Yurievich Frolov, Moscow (RU)

(21) Appl. No.: 13/902,756

(22) Filed: May 24, 2013

Related U.S. Application Data
(60) Provisional application No. 61/651,301, filed on May 24, 2012.

(51) Int. Cl. C10L 1/00; F02B 43/10

(52) U.S. Cl. CPC C10L 1/006; F02B 43/10
USPC 44/251; 123/3; 60/327

(57) ABSTRACT

An energy system may use an alternative, universal, promising, carbon-free, flameless fuel, based on an aqueous solution of ammonium nitrate and/or nitrite or mixtures thereof, wherein the ammonium nitrate and/or nitrite are used in amounts providing, upon their decomposition, a release of energy for forming high pressure vapor-gas mixture to perform work. Upon introduction of organic substances to the fuel composition, stable, homogeneous solutions may be formed also useful as fuel. An engine may perform work by initiating a reaction in on the fuel to expand a gas or fluid within an internal combustion engine or the like.

### CROSS-REFERENCE TO RELATED APPLICATION

This application claims priority under 35 U.S.C. §119(e) to U.S. provisional application Serial No. 61/651,301 filed May 24, 2012, which application is hereby incorporated by reference in its entirety.

### TECHNICAL FIELD

The present disclosure relates to the field of energy and more particularly to an flameless or weakly flammable fuel and method of using the fuel in an engine to produce work.

### BACKGROUND

An important and timely technical problem is the replacement of the standard, trivial hydrocarbon fuels derived from oil and gas by a fuel of biological origin such as methanol, as well as to find new types of driving forces in energy systems based on available and inexpensive promising compounds that are either natural or produced industrially.

To date, the primary choice of fuel for almost all modern engines of different designs and purposes are hydrocarbon fuels, which are produced from oil or gas, and whose production causes irreparable damage to the environment if handled carelessly. Also, the process of oil and gas extraction, transportation, and processing to final commercial products are associated with high financial and labor costs.

A common disadvantage of all these presently used fuels is their relatively high flammability, with related fire hazards. For engine operation using these fuels, oxygen from the air is required; engine performance deteriorates in a deficit or in the complete absence of oxygen. For example, at high altitudes, under water, in mine shafts, in the stratosphere, or in space, such engines are completely inoperable. These types of fuels currently require additional processing or refinement to improve their properties for specific applications.

It would be desirable, therefore, to provide a method and apparatus for providing and using a fuel that overcomes these and other limitations the prior art.

### SUMMARY

Methods, apparatuses, and systems for producing and using a new type of fluid fuel based on an aqueous solution of ammonium nitrate or nitrite are summarized below. This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

The present technology allows the use of alternative sources of raw materials, simplification of engine design, improvement of the coefficient of performance (efficiency), increase in service life, safety of storage and use of new fuel types, as well as elimination of environmental pollution.

The present technology relates to an alternative, universal, promising power source, designed to provide operation of engines, both known and newly developed, for different purposes and transportation types.

Providing a fuel based on water with compatible inorganic and/or organic compounds (substances) soluble therein is very important and timely. Under certain conditions, this fuel may decompose to release a significant amount of energy in the form of heat. In some embodiments, decomposition of the fuel may also supply free oxygen, which provides in combination with added organic compounds provides an increase in energy released from the fuel, and also may reduce environmental pollution.

Further embodiments, aspects and details of methods, apparatus and systems summarized above are presented in the detailed description that follows.

### BRIEF DESCRIPTION OF THE DRAWINGS

FIG. 1 is a flow chart showing aspects of a method for using a fuel of specific composition to produce work.

FIG. 2 is a flow chart showing aspects of a method for producing a fuel based on an aqueous solution of ammonium nitrate or nitrite.

### DETAILED DESCRIPTION

Under certain conditions, the ammonium salts of nitric acid and nitrous acid decompose, and some of them release a significant amount of energy in the form of heat This decomposition and heat generation also applies to substances with similar properties, and mixtures thereof, which are soluble both in water and in organic compounds, such as solvents, including those containing oxygen, dissolving and compatible with ammonium salts of nitric acid and nitrous acid, and substances with similar properties, and water, and mixtures thereof Based on the information above, depending on the desired purpose (objective), it is possible to obtain a fuel with the required physical, chemical, and thermodynamic properties, all of which can be varied by changing the composition and ratio of the components, including those which are carbon-free and flameless, weakly flammable, or those with low freezing temperatures, that operate under normal conditions, in a deficit or the complete absence of oxygen, and with different energy capacities. In this regard, the following compounds are selected as components for the proposed fuel: water, ammonium salts of nitric acid and nitrous acid, together with organic compounds, solvents such as methanol, ethanol, propanol, isopropanol, tert-butanol, glycerol, glycol or diethylene glycol, dimethyl ether, or acetone, or other substances with similar properties.

All of the components of the proposed fuel are highly compatible, soluble in each other, which allows one to obtain ideally mixed, stable, homogeneous compositions for fuel formulations, and also to lower the freezing temperature of the proposed fuels and simultaneously compensate for excess free oxygen formed by the decomposition of some substances, which is consumed during the combustion of the organic compounds in the operating chamber of the combustion engine, which increases the fuel's energy capacity.

The proposed fuel can be used in different climatic conditions, in a deficit or in the complete absence of oxygen, and can be used with most engines for many types of transportation or stationary applications. Moreover, the fuel may be formulated to be stable and to not require special additives or other modifications to make it suitable for use, such as those required for traditional fuels. Because the proposed fuels can be produced as relatively dilute aqueous solutions, they can be made fire- and explosion-proof, and to be harmless to the environment if spilled on a hard surface or on water.

To adjust the energy capacity and the freezing temperature of the proposed fuel, an organic compound is used as a component with a relatively low freezing temperature but with good compatibility and solvating properties for all of the components to form a homogeneous, stable solution which preserves the overall safety of the fuel, even if a weak, unstable flame appears during a prolonged and intense fire, which is easily extinguished with water.

The principle of the energy system for the driving force of the proposed fuel is based on the propensity of some of the compounds to degrade under certain conditions, releasing a significant amount of energy in the form of heat as well as neutral gaseous products, primarily nitrogen and water; in some cases, free oxygen allows the preservation of environmental cleanliness and reduces air consumption by the engines, or may eliminate the need to supply oxygen at all to sustain combustion. The necessary conditions for the decomposition processes of the proposed materials as fuel components exist in the operating chambers of the most known engines; this facilitates potential applications of this fuel in modern engines of different designs which are manufactured for different purposes. This also provides a rationale for consideration of the fuel as a universal alternative, promising for both known and newly designed engines, including those specifically designed for the proposed fuel, which will increase the efficiency of the engine, simplify its design and implement new materials during manufacture to make the engine inexpensive, practical, and multi-purpose.

Water has a high heat capacity, and requires a lot of energy in the form of heat for water to evaporate, which is a condition for steam engine operation and for sufficient developed steam power. The amount of energy released during the decomposition and/or combustion of the components of the proposed fuel should be sufficient to create, for each particular case, a specific required pressure of gaseous products that are formed in the engine chamber. Additionally, the conditions for the proposed compositions of these fuel formulations may be modeled in advance using theoretical calculations, which allows for the prediction of the physical and chemical properties, including the energy capacity, of the proposed fuel.

Currently all types of internal combustion engine, which operate on fuels derived from oil, gas, biomass and other similar materials, do not function in the presence of water in large amounts. Water is a very powerful means for the internal cooling of an engine. In spite of this, there has been ongoing research to develop water-containing fuels with improved flammability and combustion properties, wherein the requirements for the octane number of the fuel is reduced, the toxicity of the exhaust gases and smoke are reduced, and fuel economy is improved. Special effort has been made to produce a fire safe diesel fuel for military equipment, but with the exception of fuel oils, all attempts to create water-containing fuels with the desired existing technical capabilities are unrealistic and do not have any practical interest. In spite of this, interest in the creation of water-soluble fuels remains, especially with the development of new technological solutions. The currently recommended optimal water input into diesel fuel is less than 10%. However, this is not acceptable for practical industrial use because of the waste of fuel that accompanies the deterioration of flammability; moreover, the formation of emulsions using liquids that are insoluble in each other tends to lead to highly unstable materials, especially with water, even in presence of an emulsifier, leading to rapid phase separation. This circumstance does not allow for, or otherwise complicates, the application of emulsion fuels. Direct emulsification of the fuel at the moment of its use in internal combustion engines requires additional special equipment for the engine to produce the fresh fuel emulsions, and this makes the entire engine system significantly heavier and expensive. At the same time, this type of fuel is cost effective, environmentally safe, and does not cause corrosion of engine parts.

It is known that water is highly corrosive, therefore the proposed fuels will also have corrosive properties due to the presence of water in their composition. This corrosive property can be inhibited by certain substances, primarily organic compounds, the most effective of which are surface-active agents, subdivided into water-soluble, oil-soluble, and water/oil-soluble compounds, wherein the following compounds are acceptable with respect to corrosion of the proposed fuels: acid alkenylsuccinate, and a combined water/oil-soluble corrosion inhibitor based on nitrated oil, dialkylphosphoric acid and fatty aliphatic amines

Furthermore, water soluble and water/oil-soluble lubricants are most suitable as lubricants for friction-generating parts and engine mechanisms using the proposed fuel, for example, glycerol, ethylene glycol, diethylene glycol or other materials with similar properties, which are used as one of the proposed fuel components.

It is known that running water was used in ancient Syria to drive the wheels of irrigation facilities and to lubricate stone axles of the torque shaft, operating for thousands of years without replacing the axle of the torque shaft, and with rare and limited repair of the wheels. These wheels were made out of wood, however, and modern engines operate under harsh conditions for which the use of water as a lubricant is unknown. At the same time, modern lubricating oils and additives thereto are not miscible with water or practically insoluble in water. Surprisingly, water-soluble lubricants can be effectively used with the proposed fuel in modern internal combustion engines.

The disadvantages of all lubricating oils are that they promote carbon formation on the engine parts while mixed with gasoline, thereby straining engine operation, and also reducing the heating capacity of the fuel. Hence, the engine power characteristics are diminished.

As one of the proposed fuel components, glycerol, ethylene glycol, diethylene glycol or mixtures thereof, or their solutions, can also function as lubricants therein, similar to oils used in the fuels for two-stroke gasoline engines which do not have a special system of lubrication and where oil enters directly into the gasoline. The use of glycerol, ethylene glycol, diethylene glycol or mixtures thereof, or their solutions in the proposed fuel, instead of the currently used lubricating oils, will significantly affect the density, viscosity, and freezing temperature of the fuel with even slight changes in their concentration. The properties of glycerol, ethylene glycol, diethylene glycol or mixtures thereof, or their solutions can define their functional performance as lubricants and as a component of lubricating oils and fuels for many types of engines operating over a wide temperature range.

It is known that the longer the ignition of the operating mixture in an engine is delayed, the more power is produced and the higher the octane number of the fuel is required for providing engine operation without detonation. The most favorable ignition time of the operating mixture in the engine is determined by the following reasoning: too early ignition increases negative compression work, and too late ignition reduces positive expansion work. Therefore, the maximum efficiency of the engine cycle is at the ignition advance when the main phase of combustion is almost symmetric with respect to top dead center, while the duration of combustion in the main phase, measured by the degree of crankshaft turn at the most favorable angle of ignition, depends slightly both on the physical and chemical conditions and on the engine revolution, and is approximately 20-25 degrees. According to the above criteria, the main phase of combustion should start at about 10 degrees before the top dead center and end at 10 degrees after the top dead center, wherein the combined synchronous operation of the rest of the engine system is preserved, including valves and crankshaft, according to the regime change for the proposed fuel delivery in the operating chamber of the engine. Thus, the aqueous fuels disclosed herein are optimally introduced to an engine and ignited differently from conventional fuels, with which the fuel injection may continue until the piston passes top dead center, i.e. ahead of the ignition.

Internal combustion engines operating on liquid hydrocarbon fuels have typically dosed fuel injections in the operating chamber, wherein the fuel supply to the chamber occurs when the piston passes top dead center to the bottom one and the ignition advance angle corresponding to a crankshaft angle, expressed in degrees, is defined from ignition to the top dead center.

While using the proposed fuel for optimum operation of internal combustion engines, mainly diesel engines, the fuel can be injected into the operating combustion chamber of the engine after the piston passes through the top dead point, that is, after the piston motion begins to change from top dead center to bottom dead center, and the injection advance angle or the ignition advance angle will be defined and correspond to a crankshaft angle, expressed in degrees, after the piston passes top dead center, that is, after the piston motion begins to change from top dead center to the bottom dead center. The selection of the most favorable ignition or injection angle for the proposed fuel may be determined, and depend on, the properties and ratios of the components of the composition of the proposed fuel formulations, wherein the more stable components comprising the fuel, the greater the ignition or injection advance angle of the fuel. This angle selection can significantly and substantially change the optimal starting point of the working position of the piston of an internal combustion engine, operating with the proposed fuel from the starting point of the working position of the piston of any engine operating with any known hydrocarbon fuels.

It is known that the degree of atomization of the fuel is increased by increasing the air flow rate. Under practical conditions, good fuel atomization is achieved by fuel injection through a nozzle under high pressure, and in this case, if all other conditions are the same, the fuel atomization is better at higher injection pressures. Moreover an increase in the degree of fineness of the fuel atomization improves fuel vaporization and the formation of the working air/fuel mixture.

The proposed fuel is supplied to the operating chamber of an internal combustion engine by standard, currently used methods using a piston and rotary compressors.

In a multi-stage piston compressor the final pressure is often greater than 1000 atm. In a rotary compressor, the pressure is within a range of 3-10 atm. The design, purpose and technical characteristics of these compressors are very diverse. For the proposed fuel, the most effective compressor is an aircraft turbo compressor, which may be an axial or centrifugal supercharger driven by a gas turbine, operating on the exhaust gases of the engine. The turbo compressor is installed in piston and turbojet engines for supplying the compressed air entering the combustion chamber.

The proposed fuel has a high density (1.2 g/cm3 or higher) and a very low compressibility, therefore optimum engine performance can be affected by the injection time of the fuel into the operating chamber of piston internal combustion engines, especially diesel types. This is because the injection of the fuel can adversely affect the piston operation when working in compression mode, making it difficult to move to the top dead center. For this reason it may be more expedient to inject the fuel at or after the piston passes the top dead point, although the positive expansion work may be reduced. However, at the same time, usable engine power may still increase due to the possibility of very high pressure generation in the operating chamber of the engine when the piston moves to the top dead center. The proposed fuel may be incapable of detonation, which might otherwise limit the possibility for pressure increases inside the operating chamber when the piston moves to the top dead center, and, consequently, the generated power capacity can increase.

The fuel is characterized by individual specific physical and thermodynamic properties which include: low compressibility, low evaporation rates, low coefficients of volumetric expansion with temperature, and in addition they are non-oxidizing, non-foamable, and non-flammable, with high thermal conductivity, heat capacity, heat stability, and pumpability. Moreover, the proposed fuel is a stable, homogeneous, transparent, odorless solution. The proposed fuel can be used in turbine engines, both for their intended purpose, and for other purposes, especially in turbojet and turboprop engines, in which the turbine generates a much higher power than requirements for the rotation of the compressor. In this case, the excess power is transmitted to the combustion propeller.

Based on the properties of the proposed fuels, which are similar to those properties required for cooling lubricant oils derived from petroleum, a number of formulations of the proposed fuel may be used both as a coolant and a lubricant.

The common design principle for engines operating on the proposed fuel should be periodic, with a dosed or continuous, constant fuel supply into the engine. In the latter case, along with the existing systems, turbine or disc atomizers can be used which rotate in one or opposite directions with a small gap between them and the central fuel injection point, which may be located in the operating chamber of the engine in any different place, depending on the engine purpose and engine design.

The general condition for the operation of all engines, including turboprop, jet, turbojet, and rocket types, working with the proposed fuel, is to reach the decomposition temperature of at least one of the components of the proposed fuel located inside the operating chamber at the moment of fuel injection and/or activation by an electric spark. In the presence of ammonium nitrate, it is possible to produce nitrates of alcohols from alcohols that are components included in the proposed fuel during the operation of the engine. This can increase the caloric capacity of the fuel, affect the rate of decomposition and/or combustion of the fuel components, and, make use of the total composition of the fuel.

It is known that the presence of water in fuels, currently used for the operation of structurally different internal combustion engines and applied in many types of transportation engines as well as stationary applications, leads to a deterioration of the engine or even termination of engine operation, making it difficult to choose the proposed fuel prototype from known trivial and standard fuels.

The determining factor in engine power operating with the proposed fuel is its caloric content, which may be predicted in advance by theoretical calculations, and also the amount of fuel supplied per unit time, which is also related to the engine revolution speed. The engine operates more efficiently at high speed, especially with diesel fuel and turbo-charged conditions, as this determines the pressure and temperature in the chamber of engines. Thus, specific conditions can be created for the most effective process for the decomposition reaction and/or combustion of at least one of the components of the fuel composition. Moreover, the driving force is generated, which powers the engines. However, the operating principle of the proposed energy system for the driving force is defined by the compositions of the fuel formulations which are based on water, and inorganic and organic compounds that have never been used previously for this purpose, which significantly distinguishes the proposed fuel from all types of currently known fuels.

The technical result of said technology is the formation of a vapor-gas mixture, which is the driving force, during decomposition and/or combustion of the fuel components of the proposed fuel, which may be a flameless or weakly flammable, with various freezing temperatures, densities, viscosities and energy efficiencies, operating in normal conditions, in the deficiency or absence of oxygen. There is the possibility of theoretical calculation of the thermodynamic characteristics, and the physical, chemical and biological properties of the fuel, depending on the conditions and the problem, to determine the exact ratios of the fuel components to increase the energy efficiency of the entire fuel composition, more complete decomposition and/or combustion of the fuel components; moreover, increasing the substance content in the fuel which decomposes with the release of a significant amount of energy in the form of heat, and in some cases free oxygen, the introduction of oxygenates and/or solvents to the fuel lowers its freezing temperature, viscosity, density, and also lubricants to increase the durability of engines and structures.

The technical result is achieved by using as compositional components for fuel formulations, known available and inexpensive compounds such as water, ammonium salts of nitric, nitrous acid and mixtures thereof, and also organic compounds and solvents such as methanol, ethanol, propanol, isopropanol, tert-butanol, glycerol, glycol or ethylene glycol, diethylene glycol dimethyl ether, acetone, wherein glycerol, ethylene glycol, diethylene glycol or mixtures thereof, or compounds with similar properties, or their solutions, are used primarily as lubricants.

The problem of interest is solved by creating an alternative carbon-free flameless fuel based on aqueous solutions of ammonium nitrate and/or nitrite or mixtures thereof, wherein the decomposition of the ammonium nitrate and/or nitrite used in a specified amount provides a release of energy for formation of a high pressure vapor-gas mixture to perform work. The process of decomposition of ammonium nitrate and/or nitrite is initiated by a thermal and/or electrochemical reaction, which produces the driving force. Ammonium nitrate and/or nitrite are used in a specified amount to obtain solutions that range from diluted (e.g., 110 g per 100 g of water) to saturated (e.g., 1000 g per 100 g of water), wherein the saturated solution is characterized by the maximum possible dissolved amount of ammonium nitrate and/or nitrite at a specified temperature.

Therefore, the fuel may be characterized by the quantitative content of ammonium nitrate and/or nitrite with respect to water from 110 to 1000 g of the compound per 100 g of water. Moreover, a solution with an optimal ratio of ammonium nitrate and/or nitrite to water ranges from 150 to 400 g per 100 g of water at a solution temperature of 55° C., due to the thermal stability of the ammonium nitrite. Preferably, from an energy standpoint, the ratio of ammonium nitrate to water should range from 200 to 600 g of ammonium nitrate per 100 g of water. Also, it may be necessary to maintain the desired temperature of the solution to provide solubility. The temperature of the solution can be maintained by the flue gas temperature, resulting in the formation of the vapor-gas mixture.

Additionally, the fuel may contain inorganic carbon-free compounds for improving properties, for example, lubricants, anti-corrosives and other compounds. The problem of interest is also solved by creating alternative weakly flammable fuels comprising an aqueous solution of ammonium nitrate or nitrite, or mixtures thereof, and organic substances which are characterized by solubility of all of the fuel components, wherein the decomposition of the ammonium nitrate and/or nitrite used in an specified amount provides a release of energy for formation of high pressure vapor-gas mixture to perform work. The process of decomposition of ammonium nitrate, ammonium nitrite, or mixtures thereof, and the combustion of organic compounds, may be initiated by a thermal and/or electrochemical reaction, which rapidly heats the fuel and produces the driving force by expansion. Moreover, one or more organic compounds may be used in the fuel for lowering the freezing temperature and/or for increasing the energy characteristics of the fuel, or providing other benefits.

The fuel may contain solvents and/or oxygenates, such as methanol, ethanol, propanol, isopropanol, tertiary butanol, dimethyl ether, acetone, and mixtures thereof, or other substances with similar properties, wherein the organic compounds are used in amounts from 2 to 98 wt % with respect to the fuel. The fuel may also contain lubricants, such as glycerol, ethylene glycol, diethylene glycol or a mixture thereof, or other compounds with similar properties, wherein the organic compounds are used in amounts from 2 to 5 wt % with respect to the fuel, or other compounds with similar properties. In addition to said compounds, the fuel may contain surface active compounds which are water-soluble or water/oil soluble with anti-corrosive properties, such as acid alkenylsuccinate and water/oil soluble corrosion inhibitors based on nitrated oil, dialkylphosphoric acid, and fatty aliphatic amines or other compounds with similar properties; wherein the organic substances are used in amounts from 0.1 to 6 wt % with respect to the fuel.

The problem of interest is also solved by using an aqueous solution of ammonium nitrate, or ammonium nitrite or mixtures thereof, as an alternative fuel to generate a driving force; the ammonium nitrite or ammonium nitrate, or mixtures thereof are used to obtain a carbon-free, flameless or weakly flammable fuel.

The present technology discloses a process for preparing carbon-free, flameless or weakly flammable fuels. A production method for an alternative carbon-free, flameless fuel comprises obtaining a mixture of water and ammonium nitrate and/or nitrite, wherein the decomposition of the ammonium nitrate and/or nitrite or mixture thereof used in a specified amount provides a release of energy for formation of a high pressure vapor-gas mixture to perform work. A production method for weakly flammable alternative fuels comprises a mixture of water, ammonium nitrate and/or nitrite and organic substances, wherein the decomposition of the ammonium nitrate and/or nitrite and organic substances used in a specified amount provides a release of energy for formation of a high pressure vapor-gas mixture to perform work. Another production method for carbon-free, flameless fuel comprises formation of an aqueous solution of ammonium nitrate or a mixture of ammonium nitrate and ammonium nitrite in the neutralization reaction of ammonia and nitric acid, without isolating them in solid form. The latter production method of alternative fuels from an aqueous solution of ammonium nitrate or mixtures of ammonium nitrate and nitrite can be implemented using existing technology for the industrial preparation of these substances, which are used as fertilizer.

Furthermore, the present technology discloses particular engine design solutions, as well as methods for their operation with the claimed fuels. In particular, the engine combustion chamber should be designed to provide conditions for decomposition and/or combustion of the components of the proposed fuels to form a high-pressure vapor-gas mixture to perform work.

At the filing date of the present technology, many variations of alternative fuels have been prepared and verified experimentally, which have different compositions and ratios of the components depending on the problem of interest—production of fuels with various energy content, and physical and chemical properties. Some examples are presented in the technology to support the claimed technical result. The experimental results were later confirmed by theoretical calculations, which provided the opportunity to theoretically predict and formulate fuels with specified characteristics.

One of the components contained in the proposed fuel is water, which is one of the most widely available and cheap natural compounds on the Earth; another component is ammonium nitrate which is used as an effective fertilizer, and also ammonium nitrite, which may be obtained from air and water. Moreover, upon thermal decomposition, both ammonium nitrate and ammonium nitrite generate a significant amount of energy in the form of heat, wherein the products of decomposition are nitrogen (N2), oxygen (O2) and water (H2O) in the first case, and nitrogen (N2) and water (H2O) in the second case, which are environmentally clean substances.

The proposed fuel, depending on the composition of the components, may be flameless or weakly flammable, and this feature favorably distinguishes it from traditional fuels. Moreover, the fuel components are cheap, readily available substances, such as water and the ammonium salts of nitric acid and nitrous acid. To reduce the freezing temperature, and to improve the compatibility and the dissolution of all components during fuel preparation, organic solvents are used, including those containing oxygen and various blends of their residues, which can also serve as additional combustible materials in such fuels during fuel use, thereby increasing their calorific value. The raw materials for the components that comprise the proposed fuel are primarily water, oxygen and nitrogen, which are naturally occurring in large quantities both on land and in the air, and which, upon consumption, are easily and fully restored to their resource balance as a result of their continuous and rapid cycling in nature; moreover, they are inexpensive.

The properties of the proposed fuel change significantly due to both the variable composition of components and their ratios, which may be carbon-free, and flameless if the fuel is an aqueous solution comprising ammonium nitrate (also known as nitrate ammonia), or ammonium nitrite (also known as nitrite ammonia) or mixtures thereof, taken in wt % ratios from 1 to 99, wherein it may further comprise, in part either of glycerol or ethylene glycol, or diethylene glycol or mixtures thereof, taken in wt % ratios from 0 to 100 and from 1 to 5 with respect to the solution, which function primarily as lubricants or weakly flammable material if the fuel is from 2 to 98 wt % solution of organic substances (materials), including oxygenates and solvents.

Combining, dissolving and forming a solution of ammonium nitrate or ammonium nitrite, or mixtures thereof, wherein all the compositions of the proposed fuel formulations are homogeneous, stable, transparent, odorless, with high density (1) without detonating, incompressible or slightly compressible, flameless or weakly flammable solutions that can be stored for a long time without any changes, as various destructive factors affecting all known and adopted fuels does not affect the stability of the claimed fuels; moreover, when engines operate using the proposed fuel, there is no incrustations, gum formations or other symptoms that are harmful and may adversely affect the engine operation; moreover, the engine exhaust waste products contain only ecologically clean neutral gases without harmful impurities, which positively affects the ecology of the environment; also the proposed fuel spillage in water or on a hard surface can easily be removed by water and washed with water from a solid surface, wherein the ammonium nitrate and its aqueous solutions can be used as an effective fertilizer. The absence of detonation of the proposed fuel allows for a dramatic increase in the internal pressure of the engine cylinders in comparison with known and currently used hydrocarbon fuels, particularly diesel engines with supercharging. This greatly increases engine power, with flameless characteristics, high heat capacity, thermal conductivity, and stability. The relatively high boiling temperature of some compositions of the proposed fuel formulations enables them to be used as coolants and/or lubricants. In regard to explosions or fires in the storage areas of the proposed fuel, self-ignition or explosion is very unlikely, although in the case of a weakly flammable composition of the fuel during a prolonged and intense fire setting it may cause a weak fire that can easily be extinguished with water.

Thus, the proposed fuel is largely diversified and differs significantly and favorably from all currently known fuels derived from oil, gas and bio-products. The description above determines the comprehensive novelty of the proposed fuel, and the use of the claimed fuel as a energy system of the alternative, universal, carbon-free, flameless or, in combination with organic materials, weakly flammable fuel for the driving force in internal combustion engines is not obvious, since it is known that large amounts of water content in fuels makes it impossible to use them as the driving force of the energy system for the operation of internal combustion engines The proposed alternative, flameless or weakly flammable fuel is intended for operation of all engines, their designs and purposes in the operating chambers which provide conditions under which the decomposition and/or combustion of at least one of the components can release energy in the form of heat. The composition of the fuel formulation is adjusted depending on the purpose, the climatic conditions, and the presence or absence of oxygen.

In an aspect of the technology, an aqueous fuel may include at least one of ammonium nitrate, ammonium nitrite or the mixture of ammonium nitrate or ammonium nitrate in water in an aqueous solution, wherein a ratio of at least one of ammonium nitrate, ammonium nitrite or the mixture of ammonium nitrate and ammonium nitrite to water is greater than 0.4.

In other examples, the ratio of at least one of ammonium nitrate, ammonium nitrite or the mixture of ammonium nitrate and ammonium nitrite to water may be greater than 1, or greater than 2.

The fuel may include other components in addition to ammonium nitrate, ammonium nitrite and water. For example, the fuel may include at least one of glycerol, ethylene glycol, diethylene glycol or mixtures thereof in the aqueous solution at a concentration in the range of about 0.5 to 5 wt %. For further example, the fuel may include at least one surface active compound that is water-soluble or water/oil soluble with anti-corrosive properties, for example selected from the group consisting of acid alkenylsuccinate and water/oil soluble corrosion inhibitors based on nitrated oil, dialkylphosphoric acid and fatty aliphatic amines, in the aqueous solution at a concentration in the range of about 0.1 to 6 wt %.

An important criterion for engine operation designed for the alternative fuel is to provide conditions for the decomposition and/or combustion of one of the fuel components.

### EXAMPLE 1

Stable operation of a diesel engine brand MMZ D-246 of the Minsk Engine Plant, after adjustment of injection timing and quantity of fed fuel, was achieved using fuel of the following composition: a solution consisting of ammonium nitrate at a concentration of 63 wt % and water at a concentration of 37 wt %.

The engine noise was reduced upon addition of glycerol, ethylene glycol, diethylene glycol and mixtures thereof at concentrations from 0.5 to 5 wt %.

### EXAMPLE 2

Stable operation of a diesel engine brand MMZ D-246 of the Minsk Engine Plant, after adjustment of injection timing and quantity of fed fuel, was achieved using fuel of the following composition: a solution consisting of ammonium nitrate at a concentration of 60 wt %, water at a concentration of 30 wt %, and methanol at a concentration of 10 wt %.

Moreover, the starting crystallization temperature of ammonium nitrate salts from solution is decreased.

### EXAMPLE 3

Stable operation of a diesel engine brand MMZ D-246 of the Minsk Engine Plant, after adjustment of injection timing and quantity of fed fuel, was achieved using the fuel of the following composition: a solution consisting of ammonium nitrate at a concentration of 60 wt %, water at a concentration of 30 wt %, isopropanol at a concentration of 8 wt %, and glycerol at a concentration of 2 wt %.

Glycerol, ethylene glycol, diethylene glycol and mixtures thereof also were used at concentrations ranging from 1 to 5 wt %. A reduction in engine noise level was observed.

### EXAMPLE 4

Stable operation of the diesel engine brand MMZ D-246 of the Minsk Engine Plant, after adjustment of injection timing and quantity of fed fuel, was achieved using fuel of the following composition: a solution consisting of ammonium nitrate at a concentration of 5 wt %, water at a concentration of 62 wt %, and methanol at a concentration of 33 wt %. Engine performance deteriorated significantly when the methanol concentration was increased.

### EXAMPLE 5

Stable operation of a diesel engine brand MMZ D-246 of the Minsk Engine Plant, after adjustment of injection timing and quantity of fed fuel, was achieved using fuel of the following composition: a solution consisting of ammonium nitrate at a concentration of 45 wt %, ammonium nitrite at a concentration of 15 wt % and water at a concentration of 40 wt %.

### EXAMPLE 6

Stable operation of a diesel engine brand MMZ D-246 of the Minsk Engine Plant, after adjustment of injection timing and quantity of fed fuel, was achieved using fuel of the following composition: a solution consisting of ammonium nitrate at a concentration of 15 wt %, ammonium nitrite at a concentration of 45 wt % and water at a concentration of 40 wt %.

The power characteristics of the engine were increased upon the increasing ammonium nitrite concentration.

### EXAMPLE 7

Stable operation of the gasoline engine was achieved using fuel of the following composition: a solution consisting of ammonium nitrate at a concentration of 0.2 wt %, water at a concentration of 49.8 wt %, and ethanol at a concentration of 50 wt %.

A reduction in engine noise was observed upon the addition of glycerol, ethylene glycol, diethylene glycol and mixtures thereof at concentrations ranging from 1 to 5 wt %.

Organic compounds such as methanol, ethanol, propanol, isopropanol, tertiary butanol, dimethyl ether, acetone and mixtures thereof were used at concentrations ranging from 2 to 98 wt % as solvents, these components reducing the freezing temperature of the fuel. The results were similar.

### EXAMPLE 8

Stable operation of the gasoline engine was achieved using fuel of the following composition: a solution consisting of ammonium nitrate at a concentration of 10 wt %, ammonium nitrite at a concentration of 5 wt %, water at a concentration of 35 wt %, and ethanol at a concentration of 50 wt %.

### EXAMPLE 9

Stable operation of a rotary engine was provided by fuel of the following composition: a solution consisting of ammonium nitrate at a concentration of 10 wt %, ammonium nitrite at a concentration of 10 wt %, water at a concentration of 35 wt %, and tertiary butanol at a concentration of 45 wt %.

### EXAMPLE 10

Stable operation of the rotary engine was provided by fuel of the following composition: a solution consisting of ammonium nitrate at a concentration of 10 wt %, ammonium nitrite at a concentration of 10 wt %, water at a concentration of 35 wt %, and ethanol at a concentration of 45 wt %.

### EXAMPLE 11

Stable operation of a turbine engine was provided by fuel of the following composition: a solution consisting of ammonium nitrate at a concentration of 10 wt %, ammonium nitrite at a concentration of 50 wt %, water at a concentration of 30 wt %, isopropanol at a concentration of 8 wt %, and glycerol at a concentration of 2 wt %.

For all of engine designs, compounds such as methanol, ethanol, propanol, isopropanol, tertiary butanol, dimethyl ether, acetone and mixtures thereof were used during the experiments, at concentrations ranging from 2 to 98 wt % with respect to the fuel, as components for lowering the freezing temperatures and the additional organic fuel. The addition of small amounts of an anti-corrosive compound, acid alkenylsuccinate, and a combined water/oil soluble corrosion inhibitor based on nitrated oil, as well as dialkylphosphoric acid and fatty aliphatic amines to the composition of the fuels did not affect engine operation and helped to reduce corrosion.

Based on the fact that the principal behavior of the claimed compounds (substances) as an energy system for a fuel driving force is essentially the same for all compositions of possible component combinations for fuel formulations, the data obtained from some experiments are not always in the text of the description, or else they are presented without detail; this is also done to preserve the field priority and to save time for the research process. Some of the results have a certain relationship and convergence under the use (application) conditions of the proposed substances (compounds) both in combination (mixture) with water and with compatible organic compounds (substances).

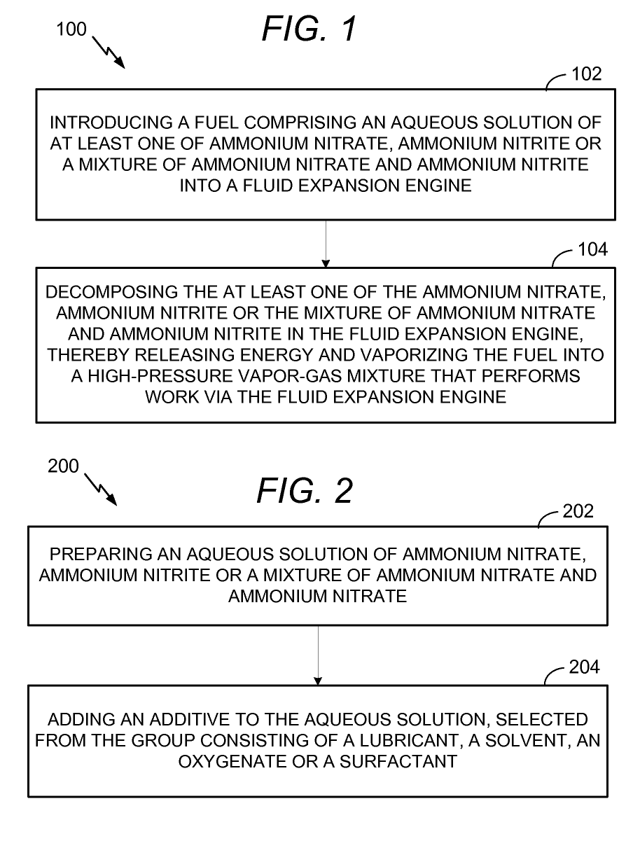

In summary of portions of the foregoing disclosure, as shown in FIG. 1, a method 100 for obtaining work from a fluid may include, at 102, supplying a fuel comprising an aqueous solution of at least one of ammonium nitrate, ammonium nitrite or a mixture of ammonium nitrate and ammonium nitrite into a fluid expansion engine. A fluid expansion engine may include, for example, an internal combustion engine, for example a diesel engine or gasoline engine. Supplying the fuel to a combustion chamber of the engine may be timed to occur at or after each piston of the engine passes the top dead point. The method may further include, at 104, decomposing the at least one of the ammonium nitrate, ammonium nitrite or the mixture of ammonium nitrate and ammonium nitrite in the fluid expansion engine, thereby releasing energy and vaporizing the fuel into a high-pressure vapor-gas mixture that performs work via the fluid expansion engine.

Further aspects of the method 100 may include, for example, initiating the decomposing by at least one of a thermal or electrochemical reaction. In another aspect, the aqueous solution of the fuel may be in a range from diluted to saturated, wherein a saturated solution is characterized by a maximum possible quantity of the at least one of the ammonium nitrate, ammonium nitrite or the mixture of ammonium nitrate and ammonium nitrite at a specified temperature. In some embodiments, the aqueous solution of the fuel may include the mixture of ammonium nitrate and ammonium nitrite at a concentration in the range of 60-80 wt % in water. In alternative embodiments, the aqueous solution of the fuel may include ammonium nitrate at a concentration in the range of 50-70 wt % in water. The aqueous solution may exclude other substances, or more commonly, may include additional materials for example lubricants, surfactants, oxygenates or solvents.

In another aspect of the method 100, the fuel further includes inorganic carbon-free compounds selected from lubricants or anti-corrosives. In the alternative, or in addition, the aqueous solution of the fuel may further include one or more organic compounds. For example, the fuel further may further include at least one solvent or oxygenate selected from the group consisting of methanol, ethanol, propanol, isopropanol, tertiary butanol, dimethyl ether, acetone, or a mixture thereof, in amounts from 2 to 98 wt % of the fuel. For further example, the fuel further may include at least one lubricant selected from the group consisting of glycerol, ethylene glycol, diethylene glycol or a mixture thereof, in amounts from 2 to 5 wt % of the fuel. For further example, the fuel may include at least one surface active compound that is water-soluble or water/oil soluble with anti-corrosive properties, selected from the group consisting of acid alkenylsuccinate and water/oil soluble corrosion inhibitors based on nitrated oil, dialkylphosphoric acid and fatty aliphatic amines, in amounts from 0.1 to 6 wt % of the fuel.

By way of example, a method 200 of producing an aqueous fuel as shown herein is shown in FIG. 2. The method 200 may include, at 202, preparing an aqueous solution of ammonium nitrate, ammonium nitrite or a mixture of ammonium nitrate and ammonium nitrate. In an aspect, a mass ratio of at least one of ammonium nitrate, ammonium nitrite or the mixture of ammonium nitrate and ammonium nitrite to water may be greater than about 0.4. The method 200 may further include, at 204, adding an additive to the aqueous solution, selected from the group consisting of a lubricant, a solvent, an oxygenate or a surfactant.

The method 200 may further include preparing the aqueous solution by a neutralization reaction of ammonia and nitric acid, without isolating the ammonia or nitric acid in solid form. In an alternative, the method may include preparing the aqueous solution by dissolving the at least one of ammonium nitrate, ammonium nitrite or the mixture of ammonium nitrate and ammonium nitrite in water.

In other aspects of the method 200, the aqueous solution may include ammonium nitrate at a concentration in the range of 50-70 wt % in water. The method 200 may include adding to the aqueous solution at least one of glycerol, ethylene glycol, diethylene glycol or mixtures thereof to a concentration in the range of about 0.5 to 5 wt %.

The method 200 may further include adding to the aqueous solution at least one solvent or oxygenate selected from the group consisting of methanol, ethanol, propanol, isopropanol, tertiary butanol, dimethyl ether, acetone, or a mixture thereof, to a concentration in the range of about 30 to 98 wt %. In the alternative, the method 200 may include adding to the aqueous solution at least one solvent or oxygenate selected from the group consisting of methanol, ethanol, propanol, isopropanol, tertiary butanol, dimethyl ether, acetone, or a mixture thereof, to a concentration in the range of about 2 to 30 wt %.

In another aspect, the method 200 may include adding to the aqueous solution at least one surface active compound that is water-soluble or water/oil soluble with anti-corrosive properties, selected from the group consisting of acid alkenylsuccinate and water/oil soluble corrosion inhibitors based on nitrated oil, dialkylphosphoric acid and fatty aliphatic amines, to a concentration in the range of about 0.1 to 6 wt %.

The previous description of the disclosed embodiments is provided to enable any person skilled in the art to make or use the embodiments disclosed. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for obtaining work from a fluid, comprising:
introducing a fuel comprising an aqueous solution of at least one of ammonium nitrate, ammonium nitrite or a mixture of ammonium nitrate and ammonium nitrite into a fluid expansion engine;
decomposing the at least one of the ammonium nitrate, ammonium nitrite or the mixture of ammonium nitrate and ammonium nitrite in the fluid expansion engine, thereby releasing energy and vaporizing the fuel into a high-pressure vapor-gas mixture that performs work via the fluid expansion engine.

2. The method of claim 1, further comprising initiating the decomposing by at least one of a thermal or electrochemical reaction.

3. The method of claim 1, wherein the aqueous solution of the fuel is in a range from diluted to saturated, wherein a saturated solution is characterized by a maximum possible quantity of the at least one of the ammonium nitrate, ammonium nitrite or the mixture of ammonium nitrate and ammonium nitrate at a specified temperature.

4. The method of claim 1, wherein the fuel further comprises inorganic carbon-free compounds selected from lubricants or anti-corrosives.

5. The method of claim 1, wherein the aqueous solution of the fuel further comprises one or more organic compounds.

6. The method of claim 5, wherein the fuel further comprises at least one solvent or oxygenate selected from the group consisting of methanol, ethanol, propanol, isopropanol, tertiary butanol, dimethyl ether, acetone, or a mixture thereof, in amounts from 2 to 98 wt % of the fuel.

7. The method of claim 5, wherein the fuel further comprises at least one lubricant selected from the group consisting of glycerol, ethylene glycol, diethylene glycol or a mixture thereof, in amounts from 2 to 5 wt % of the fuel.

8. The method of claim 5, wherein the fuel further comprises at least one surface active compound that is water-soluble or water/oil soluble with anti-corrosive properties, selected from the group consisting of acid alkenylsuccinate and water/oil soluble corrosion inhibitors based on nitrated oil, dialkylphosphoric acid and fatty aliphatic amines, in amounts from 0.1 to 6 wt % of the fuel.

9. The method of claim 1, wherein the fluid expansion engine comprises a diesel engine.

10. The method of claim 9, further comprising supplying the fuel to a combustion chamber of the diesel engine at or after each piston passes the top dead point.

11. A method of producing an aqueous fuel, comprising preparing an aqueous solution of ammonium nitrate, ammonium nitrite or a mixture of ammonium nitrate and ammonium nitrate, wherein a ratio of at least one of ammonium nitrate, ammonium nitrite or the mixture of ammonium nitrate and ammonium nitrite to water is not less than about 0.4.

12. The method of claim 11, wherein preparing the aqueous solution comprises reacting ammonia and nitric acid, without isolating the ammonia or nitric acid in solid form.

13. The method of claim 11, wherein preparing the aqueous solution comprises dissolving the at least one of ammonium nitrate, ammonium nitrite or the mixture of ammonium nitrate and ammonium nitrite in water.

14. The method of claim 11, wherein the aqueous solution comprises ammonium nitrate at a concentration in the range of 50-70 wt % in water.

15. The method of claim 11, wherein the aqueous solution comprises the mixture of ammonium nitrate and ammonium nitrite at a concentration in the range of 60-80 wt % in water.

16. The method of claim 11, further comprising adding an additive to the aqueous solution, selected from the group consisting of a lubricant, a solvent, an oxygenate or a surfactant.

17. The method of claim 11, further comprising adding to the aqueous solution at least one of glycerol, ethylene glycol, diethylene glycol or mixtures thereof to a concentration in the range of about 0.5 to 5 wt %.

18. The method of claim 11, further comprising adding to the aqueous solution at least one solvent or oxygenate selected from the group consisting of methanol, ethanol, propanol, isopropanol, tertiary butanol, dimethyl ether, acetone, or a mixture thereof, to a concentration in the range of about 30 to 98 wt %.

19. The method of claim 11, further comprising adding to the aqueous solution at least one solvent or oxygenate selected from the group consisting of methanol, ethanol, propanol, isopropanol, tertiary butanol, dimethyl ether, acetone, or a mixture thereof, to a concentration in the range of about 2 to 30 wt %.

20. The method of claim 11, further comprising adding to the aqueous solution at least one surface active compound that is water-soluble or water/oil soluble with anti-corrosive properties, selected from the group consisting of acid alkenylsuccinate and water/oil soluble corrosion inhibitors based on nitrated oil, dialkylphosphoric acid and fatty aliphatic amines, to a concentration in the range of about 0.1 to 6 wt %.

21. An aqueous fuel, comprising at least one of ammonium nitrate, ammonium nitrite or a mixture of ammonium nitrate and ammonium nitrate in an aqueous solution, wherein a ratio of at least one of ammonium nitrate, ammonium nitrite or the mixture of ammonium nitrate and ammonium nitrite to water is not less than about 0.4.

22. The fuel of claim 21, further comprising at least one of glycerol, ethylene glycol, diethylene glycol or mixtures thereof in the aqueous solution at a concentration in the range of about 0.5 to 5 wt %.

23. The fuel of claim 21, further comprising at least one solvent or oxygenate selected from the group consisting of methanol, ethanol, propanol, isopropanol, tertiary butanol, dimethyl ether, acetone, or a mixture thereof, in the aqueous solution at a concentration in the range of about 30 to 98 wt %.

24. The fuel of claim 21, further comprising at least one solvent or oxygenate selected from the group consisting of methanol, ethanol, propanol, isopropanol, tertiary butanol, dimethyl ether, acetone, or a mixture thereof, in the aqueous solution at a concentration in the range of about 2 to 30 wt %.

25. The fuel of claim 21, further comprising at least one surface active compound that is water-soluble or water/oil soluble with anti-corrosive properties, selected from the group consisting of acid alkenylsuccinate and water/oil soluble corrosion inhibitors based on nitrated oil, dialkylphosphoric acid and fatty aliphatic amines, in the aqueous solution at a concentration in the range of about 0.1 to 6 wt %.

26. The fuel of claim 21, wherein a ratio of at least one of ammonium nitrate, ammonium nitrite or the mixture of ammonium nitrate and ammonium nitrite to water is in the range of about 0.4 to 1.

27. The fuel of claim 21, wherein a ratio of at least one of ammonium nitrate, ammonium nitrite or the mixture of ammonium nitrate and ammonium nitrite to water is in the range of about 1 to 2.

28. The fuel of claim 21, wherein a ratio of at least one of ammonium nitrate, ammonium nitrite or the mixture of ammonium nitrate and ammonium nitrite to water is greater than 2.
